(19) United States
(12) Patent Application Publication
(10) Pub. No.: US 2025/0277920 A1
(43) Pub. Date: Sep. 4, 2025

(54) CHARGING DEVICE AND SECURITY INSPECTION DEVICE

(71) Applicant: SHENZHEN CHECKPOINT SECURITY ELECTRONICS CO., LTD., SHENZHEN (CN)

(72) Inventor: MAOQUAN DENG, SHENZHEN (CN)

(21) Appl. No.: 18/599,212

(22) Filed: Mar. 8, 2024

(30) Foreign Application Priority Data
Mar. 1, 2024 (CN) 202420398852.X

(51) Int. Cl. G01V 3/10; H02J 7/00

(52) U.S. Cl. CPC G01V 3/10; H02J 7/0042

(57) ABSTRACT

The application disclosed a charging device and security inspection device. The body of the charging device is formed into a charging placing surface, and the first magnetic part is arranged on the side of the charging placing surface facing the inside of the charging device. The first magnetic suction portion is used to fix the metal detector onto the charging placement surface. When the metal detector needs to be picked up from the charging device, the metal detector can be picked up by grasping the handle of the metal detector overcoming the magnetic force of the first magnetic suction portion. Compared with traditional charging devices, there is no need to first take the metal detector's detection part and then convert the holding position.

### CROSS REFERENCE TO RELATED APPLICATIONS

This application claims priority to Chinese Application No. 202420398852.X, entitled “CHARGING DEVICE AND SECURITY INSPECTION DEVICE” filed on Mar. 1, 2024, which is hereby incorporated by reference herein as if set forth in its entirety.

### TECHNICAL FIELD

The application relates to the field of security inspection device technology, specifically a charging device and security inspection device.

### BACKGROUND OF THE APPLICATION

Handheld metal detectors are commonly used tools in security inspection, such as, handheld metal detectors are used in airports, train stations, and other important places to prevent the carrying of dangerous metal items. However, one of the significant challenges these devices face is the method of charging.

Traditional charging methods generally require placing the handle of the handheld metal detector in a charging slot. The process of placing the handheld metal detector require precise alignment and secure placement, which can be time-consuming and inconvenient, especially in high-traffic situations where quick response times are crucial.

### DESCRIPTION OF THE APPLICATION

To solve the problems in the background, the application provides a charging device and a security inspection device, which feature an integrated magnetic design. This design make it easier and faster to pick up or place the handheld metal detector from the charging device.

The first objective of the application is to provide a charging device, the charging device comprises a body and a first magnetic suction portion;
the body, formed with a charging placement surface, the charging placement surface is used to cooperate with a detection portion of a metal detector;
the first magnetic suction portion, disposed on the body, and located on a side of the charging placement surface facing an inside of the charging device, the first magnetic suction portion is used to fix the metal detector onto the charging placement surface.

In one embodiment, the body further forms an avoiding surface, the avoiding surface connects to the charging placement surface, and the avoiding surface is tilted relative to the charging placement surface, and the avoiding surface deviates from the metal detector, the avoiding surface is used to avoid the detection portion of the metal detector.

In another embodiment, the charging placement surface is tilted relative to a bottom surface of the body, wherein an angle between the charging placement surface and the bottom surface of the body is 40°-50°.

In another embodiment, the body forms an storage cavity, wherein the storage cavity forms a positioning slot for fixing a sensitivity calibration tester.

In another embodiment, the body comprises an outer shell, an inner shell and a base, wherein the inner shell is disposed on the base and forms the storage cavity with the base, and the outer shell is sleeved outside the inner shell,
the outer shell forms the charging placement surface, wherein a side of the charging placement surface facing the inner shell bas a mounting groove, and the first magnetic suction portion is embedded in the mounting groove;
the inner shell has an installation surface corresponding to the charging placement surface, wherein the installation surface is provided with a charging portion;
the base forms the positioning slot.

In another embodiment, a counterweight portion is disposed on the base;
a counterweight tank is formed in the base, the counterweight portion is embedded in the counterweight tank, and the detachable cover of the counterweight tank is provided with a cover plate.

In another embodiment, the base forms a connecting groove on a side away from the inner shell, wherein an edge of the side away from the inner shell forms a connecting opening, and the connecting groove is connected to the connecting opening.

The second objective of application is to provide a security inspection device, the security inspection device comprises a metal detector and any one of the aforesaid the charging device;
the metal detector, having a detection portion and a handle portion, wherein the detection portion is provided with a second magnetic suction portion and an metal sensing coil, the second magnetic suction portion is used to cooperate with the first magnetic suction portion of the charging device, and the metal sensing coil is used to detect metal.

In one embodiment, the second magnetic suction portion is located at an end of the detection portion close to the handle portion, and the metal sensing coil is located at an end of the detection portion away from the handle portion.

In another embodiment, when the body of the charging device comprises an outer shell, an inner shell and a base, and a side of the base away from the inner shell forms a connecting groove, an edge of the side away from the inner shell forms a connecting opening, and the connecting groove is connected to the connecting opening;
the security inspection device comprises at least two charging devices and at least one connecting member, wherein two ends of the connecting member are formed with avoiding slots, wherein the avoiding slots divide protruding ends on the connecting member, the protruding ends are embedded into the connecting grooves, and the edges of the base where the connecting openings are located are embedded into the avoiding slots.

The beneficial effects of the application are:

1. When the metal detector needs to be picked up from the charging device, the metal detector can be picked up by grasping the handle of the metal detector overcoming the magnetic force of the first magnetic suction portion. Compared with traditional charging devices, there is no need to first take the metal detector's detection part and then convert the holding position.

2. The body of the charging device forms a storage cavity, and the positing slot in the storage cavity can be used to place the sensitivity calibration tester, which is convenient for users to use the sensitivity calibration tester to calibrate the working state of the metal detector before using.

3. A counterweight portion is arranged on the base of the charging device body. When the charging device is placed on the ground, the counterweight portion can ensure the stability of the charging device When charging device is fixed on the wall, the counterweight portion can be removed to reduce the weight of the charging device. This design improve the flexibility of charging device installation and use.

### BRIEF DESCRIPTION OF THE DRAWINGS

To further clarify the implementation of this present application, a brief introduction to the drawings needed for describing the embodiments or existing technology follows. Obviously, the drawings described below represent only some embodiments of this present application. For those skilled in the art, other drawings can be obtained without creative effort based on these drawings.

FIG. 1 is a structure diagram of the first view of the charging device provided by an embodiment of the present application.

FIG. 2 is a structure diagram of the second view of the charging device provided by an embodiment of the present application.

FIG. 3 is an exploded view of the charging device provided by an embodiment of the present application.

FIG. 4 is a structure diagram of the housing of the charging device provided by an embodiment of the present application.

FIG. 5 is a structure diagram of one side of the base away from the inner shell of the charging device provided by an embodiment of the present application.

FIG. 6 is a structure diagram of the security inspection device provided by an embodiment of the present application.

FIG. 7 is an exploded view of the metal detector of the security inspection device by an embodiment of the present application.

FIG. 8 is a structure diagram of a plurality of charging devices connected by a connecting member of the security inspection device by an embodiment of the present application.

FIG. 9 is a structure diagram of the connecting member of the security inspection device by an embodiment of the present application.

### LIST OF REFERENCES AND FIGURES

100—charging device; 10—body; 11—housing; 111—charging placement surface; 111a—first side; 111b—second side; 112—avoiding surface; 113—mounting groove; 114—limit protrusion; 12—inner shell; 121—installation surface; 13—base; 131—counterweight portion; 132—counterweight tank; 133—cover plate; 134—positioning slot; 135—connecting groove; 136—connecting opening; 14—storage cavity; 15—charging portion; 20—first magnetic suction portion; 200—metal detector; 201—detection portion; 202—handle portion; 203—second magnetic suction portion; 204—metal sensing coil; 300—connecting member; 301—avoiding slot; 302—protruding ends; 400—sensitivity calibration tester.

### PREFERRED EMBODIMENT OF THE APPLICATION

The technical solutions in the embodiments of the application will be clearly and completely described below with reference to the accompanying drawings. Apparently, the described embodiments are only some embodiments of the application, not all embodiments. All other embodiments obtained by a person of ordinary skill in the art based on the embodiments of the application without creative efforts shall fall within the protection scope of the application.

The term “embodiment” mentioned herein means that the specific features, structures or characteristics described in combination with the embodiments may be included in at least one embodiment of the present application. The appearances of this phrase at various places in the specification do not necessarily all refer to the same embodiment, nor are they mutually exclusive, independent or alternative embodiments. Those skilled in the art understand explicitly and implicitly that the embodiments described herein may be combined with other embodiments.

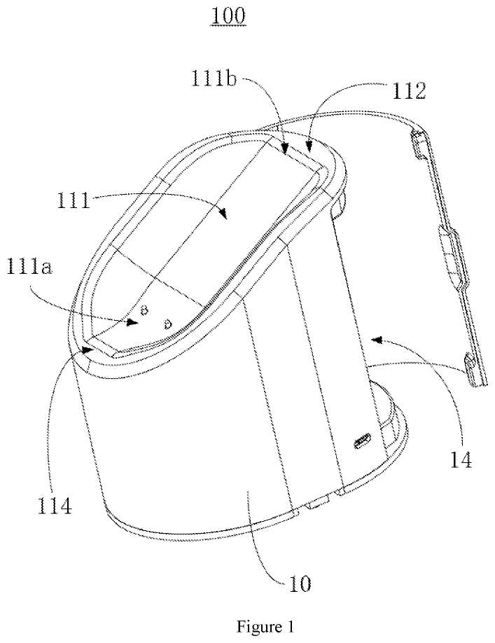

Referring to FIGS. 1-3 and FIG. 6, the present application provides a charging device 100 that can be used to charge a metal detector 200. The charging device 100 comprises a body 10 and a first magnetic suction portion 20. The body 10 of the charging device 100 is formed with a charging placement surface 111 for cooperating with the detecting portion 201 of the metal detector 200. The first magnetic suction portion 20 is disposed on the body 10 and located on a side of the charging placement surface 111 facing the inside of the charging device 100. The first magnetic suction part 20 is used to fix the metal detector 200 to the charging placement surface 111.

It should be noted that the metal detector 200 generally includes a detecting portion 201 and a handle portion 202, where the detecting portion 201 is provided with a metal sensing coil 204. In use, the user holds the handle portion 202 of the metal detector 200 and scans the object to be inspected with the detecting portion 201 of the metal detector 200. The placement surface formed by the charging device 100 provided in the present application is used to cooperate with the detecting portion 201 of the metal detector 200. That is, the detecting portion 201 of the metal detector 200 cooperates with the charging placement surface 111. The user's operation of placing and removing the metal detector 200 can be completely accomplished by holding the handle portion 202 of the metal detector 200 without switching the holding part of the metal detector 200. It can be understood that the detecting portion 201 of the metal detector 200 has a second magnetic suction portion 203 cooperating with the first magnetic suction portion 20. The first magnetic suction portion 20 and the second magnetic suction portion 203 may both be magnets, or one may be a magnet and the other may be a metal that can be magnetically sucked. By providing the first magnetic suction portion 20 in the charging device 100 and using the cooperation between the first magnetic suction portion 20 of the charging device 100 and the second magnetic suction portion 203 of the metal detector 200, not only can the metal detector 200 be fixed on the charging placement surface 111, but also the placing position of the metal detector 200 on the charging placement Surface 111 can be corrected by magnetic force to ensure that the metal detector 200 is aligned with the charging portion 15 of the body 10.

Since the detecting portion 201 of the general metal detector 200 has a certain size in the longitudinal direction, in the longitudinal direction of the metal detector 200, a part of the detecting portion 201 can be in contact with the charging placement surface 111, and the end of the detecting portion 201 away from the handle portion 202 protrudes from the charging placement surface 111.

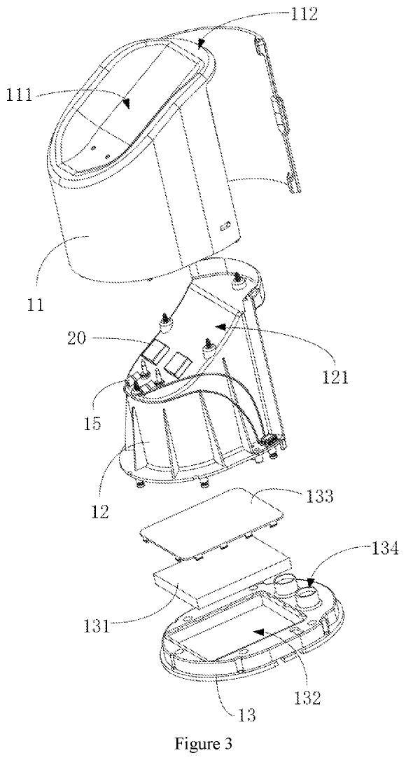

As shown in FIGS. 1 and 3, in an embodiment, the body 10 also forms an avoiding surface 112. The avoiding surface 112 connects to the charging placement surface 111. The avoiding surface 112 is tilted relative to the charging placement surface 111, and the avoiding surface 112 deviates from the metal detector 200. The avoiding surface 112 is used to avoid the detection portion 201 of the metal detector 200.

When the size of the detecting portion 201 of the metal detector 200 is relatively large compared to the size of the placement surface of the charging device 100 in its longitudinal direction, the end of the detecting portion 201 away from the handle portion 202 will protrude from the charging placement surface 111. The avoiding surface 112 of the charging device 100 is used to avoid the detecting portion 201 of the metal detector 200. For example, the charging placement surface 111 has opposite first side 111a and second side 111b. The metal detector 200 is placed on the charging placement surface 111 along the direction from the first side 111a to the second side 111b. The handle portion 202 of the metal detector 200 is located on the first side 111a of the charging placement surface 111, and the end of the detecting portion 201 of the metal detector 200 away from the handle portion 202 protrudes from the second side 111b of the charging placement surface 111. Correspondingly, the avoiding surface 112 is connected to the second side 111b of the charging placement surface 111. As shown in FIGS. 1 and 3, when the charging device 100 is in the normal use state, the avoiding surface 112 is tilted relative to the charging placement surface 111, and the avoiding surface 112 deviates from the metal detector 200, that is, the avoiding surface 112 is inclined downward to ensure the stability of the metal detector 200 placed on the charging placement surface 111.

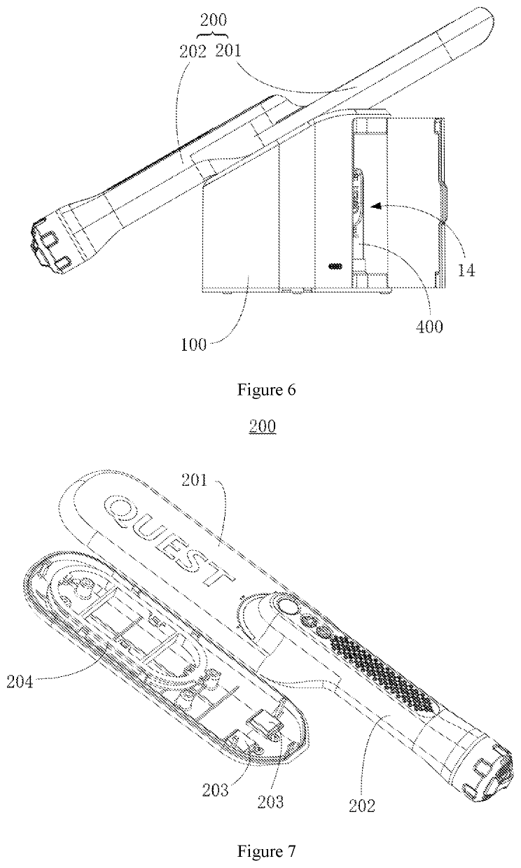

As shown in FIGS. 1 and 6, in an embodiment, the charging placement surface 111 of the charging device 100 is inclined relative to the bottom surface of the body 10, and the angle between the charging placement surface 111 and the bottom surface of the body 10 is 40°-50°. For example, the angle between the charging placement surface 111 and the bottom surface of the body 10 may be 40°, 45° or 50°, but is not limited thereto. By making the charging placement surface 111 inclined about 45 degrees relative to the bottom surface of the body 10, it is convenient for the user to place and remove the metal detector 200.

It should be noted that the charging placement surface 111 is inclined relative to the bottom surface of the body 10, which means that the charging placement surface 111 is inclined along the direction from the first side 111a to the second side 111b. The first side 111a higher than the second side 111b, or the second side 111b higher than the first side 111a. The metal sensing coil 204 in the metal detector 200 is generally disposed at one end of the detecting portion 201 away from the handle portion 202. In order to avoid the influence of the second magnetic suction portion 203 on the metal sensing coil 204, the second magnetic suction portion 203 may be disposed at one end of the detecting portion 201 close to the handle portion 202. Thus, in an embodiment, the second side 111b of the charging placement surface 111 is higher than the first side 111a to prevent the metal detector 200 from slipping off the first side 111a of the charging placement surface 111. A limiting protrusion 114 can also be arranged on the first side 111a of the charging placement surface 111.

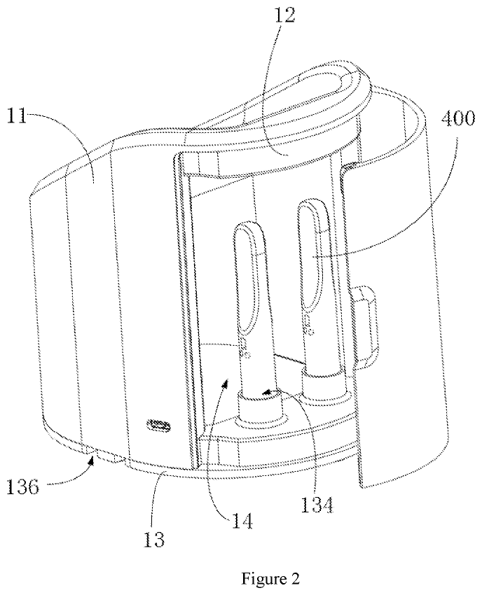

As shown in FIGS. 1 and 2, in an embodiment, the body 10 of the charging device 100 also forms an storage cavity 14 in which a positioning slot 134 is formed for fixing a sensitivity calibration tester 400.

The body 10 of the charging device 100 is a shell structure with an storage cavity 14, and the storage cavity 14 can be used for storage. It should be noted that in order to ensure the normal working status of the metal detector 200, the metal detector 200 generally needs to use a sensitivity calibration tester 400 before daily use to calibrate the sensitivity of the metal detector 200. By forming the positioning slots 134 in the accommodating cavity 14, the sensitivity calibration tester 400 can be inserted into the positioning slot 134. The positioning slot 134 may be a cylindrical groove, but is not limited thereto. The present application does not limit the specific number of positioning slots 134 in the accommodating cavity 14, for example, two positioning slots 134 may be provided, corresponding to accommodating two sensitivity calibration testers 400.

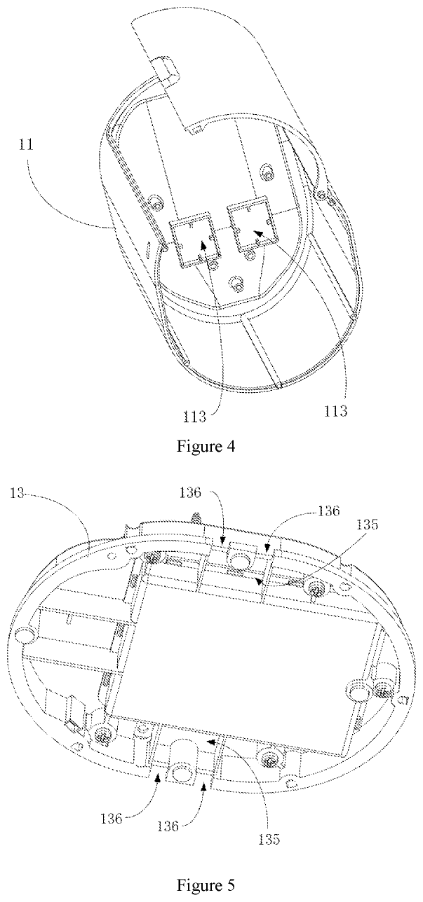

As shown in FIG. 3, in an embodiment, the body 10 of the charging device 100 may include an outer shell 11, an inner shell 12 and a base 13. The inner shell 12 is disposed on the base 13 and forms the storage cavity 14 with the base 13. The outer shell 11 is sleeved outside the inner shell 12. The charging placement surface 111 of the body 10 is formed on the outer shell 11. Referring also to FIG. 4, the charging placement surface 111 of the outer shell 11 facing the inner shell 12 has a mounting groove 113, and the first magnetic suction portion 20 of the charging device 100 is embedded in the mounting groove 113. The inner shell 12 has an installation surface 121 corresponding to the charging placement surface 111 of the outer shell 11. The installation surface 121 is provided with a charging portion 15. The positioning slot 134 in the accommodating cavity 14 is formed in the base 13. The positioning slot 134 on the base 13 is located in the accommodating cavity 14 after the inner shell 12 cooperates with the base 13.

The installation surface 121 of the inner shell 12 corresponding to the charging placement surface 111 of the outer shell 11 means that after the outer shell 11 is sleeved outside the inner shell 12, the installation surface 121 is directly below the charging placement surface 111, so that the charging portion 15 on the mounting surface 121 can charge the metal detector 200 placed on the charging placement surface 111. The charging portion 15 on the mounting surface 121 may charge the metal detector 200 on the charging placement surface 111 by electromagnetic induction, or may charge by contact between spring pins and the metal detector 200, but is not limited thereto. It can be understood that the charging portion 15 also includes a charging control module for controlling the start and stop of the charging portion 15. The charging control module may include an overheating protection circuit unit, a short circuit protection circuit unit, and an overcharge protection circuit unit.

The charging device 100 provided in this application can be placed on the ground or fixed on a vertical wall. In order to ensure the stability of the charging device 100 placed on the ground, a counterweight portion 131 is also arranged on the base 13. In an embodiment, in order to realize the installation of the counterweight portion 131 on the base 13, a counterweight tank 132 may be formed in the base 13, and the counterweight portion 131 is embedded in the counterweight tank 132. And the cover plate 133 is covered on the counterweight tank 132 detachably.

The counterweight portion 131 may be made of a material with a large density, for example, the material of the counterweight portion 131 may be iron, but is not limited thereto. By forming a counterweight groove 132 on the base 13, placing the counterweight portion 131 in the counterweight groove 132, and then covering the detachable cover plate 133 on the counterweight groove 132, the detachability of the counterweight portion 131 is realized. When the charging device 100 needs to be installed on a vertical wall, the counterweight portion 131 can be removed from the counterweight groove 132. The detachable mode of the cover plate 133 may be a snap-fit connection or a threaded fastener connection, but is not limited thereto. For easy installation and disassembly of the counterweight portion 131, the detachable connection between the inner shell 12 and the base 13 and between the outer shell 11 and the base 13 may also be snap-fit or threaded fasteners.

Referring also to FIG. 5, in an embodiment, the base 13 forms a connecting groove 135 on a side away from the inner shell 12, and an edge of the side away from the inner shell 12 forms a connecting opening 136, and the connecting groove 135 is connected to the connecting opening 136.

The base 13 of the body 10 is provided with a connecting groove 135 and a connecting opening 136 so that when multiple charging devices 100 are juxtaposed, the connecting member 300 can extend from the connecting opening 136 of the base 13 into the bottom of the base 13 to cooperate with the connecting groove 135, thereby connecting adjacent charging devices 100 to improve stability. It should be noted that when multiple charging devices 100 are arranged side by side, both sides of the charging device 100 need to be connected to the adjacent charging device 100 through the connecting member 300. It can be understood that the connecting groove 135 and the connecting opening 136 of the base 13 are formed on opposite sides of the base 13.

Referring also to FIGS. 6 and 7, in other embodiments, the present application also provides a security inspection device. The security inspection device includes a metal detector 200 and a charging device 100 in any of the foregoing embodiments. The metal detector 200 has a detecting portion 201 and a handle portion 202. The detecting portion 201 is provided with a second magnetic suction portion 203 and an metal sensing coil 204. The second magnetic suction portion 203 is used to cooperate with the first magnetic suction portion 20 of the charging device 100. The metal sensing coil 204 is used to detect metal.

The second magnetic suction portion 203 in the detecting portion 201 is a magnet or metal that can be magnetically sucked. In order to avoid the influence of the second magnetic suction portion 203 on the metal sensing coil 204, the second magnetic suction portion 203 is disposed at an end of the detecting portion 201 close to the handle, and the metal sensing coil 204 is disposed at an end of detecting portion 201 away from the handle.

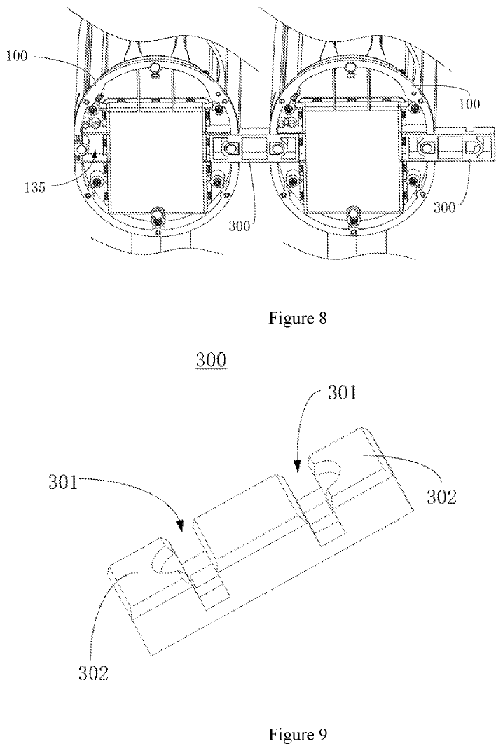

Referring also to FIGS. 8 and 9, in an embodiment, when the body 10 of the charging device 100 includes an outer shell 11, an inner shell 12 and a base 13, and a side of the base 13 away from the inner shell 12 forms The connecting tank 135 has a connecting opening 136 on the edge of the side away from the inner shell 12, and the connecting groove 135 is connected to the connecting opening 136. The security inspection device may include at least two charging devices 100 and at least one connecting member 300. Both ends of the connecting member 300 are formed with avoiding grooves 301. The avoiding grooves 301 divide protruding ends 302 on the connecting member 300. The protruding ends 302 are embedded in the connecting grooves 135 of the base 13, and the edges of the base 13 where the connecting openings 136 are located are embedded in the avoiding grooves 301.

When the security inspection device has multiple charging devices 100, each adjacent two charging devices 100 are connected by one connecting member 300, which can connect multiple charging devices 100 to ensure stability of multiple charging devices 100 placed in the security inspection device.

The security inspection device provided in this application adopts all the technical solutions of all the embodiments of the charging device 100, and thus at least has all the beneficial effects brought by the technical solutions of the embodiments of the charging device 100, which will not be repeated here.

1. A charging device, comprises a body and a first magnetic suction portion;
the body, formed with a charging placement surface, the charging placement surface is used to cooperate with a detection portion of a metal detector;
the first magnetic suction portion, disposed on the body, and located on a side of the charging placement surface facing an inside of the charging device, the first magnetic suction portion is used to fix the metal detector onto the charging placement surface.

2. The charging device according to claim 1, the body further forms an avoiding surface, the avoiding surface connects to the charging placement surface, and the avoiding surface is tilted relative to the charging placement surface, and the avoiding surface deviates from the metal detector, the avoiding surface is used to avoid the detection portion of the metal detector.

3. The charging device according to claim 1, the charging placement surface is tilted relative to a bottom surface of the body, wherein an angle between the charging placement surface and the bottom surface of the body is 40°-50°.

4. The charging device according to claim 1, the body forms an storage cavity, wherein the storage cavity forms a positioning slot for fixing a sensitivity calibration tester.

5. The charging device according to claim 4, the body comprises an outer shell, an inner shell and a base, wherein the inner shell is disposed on the base and forms the storage cavity with the base, and the outer shell is sleeved outside the inner shell;
the outer shell forms the charging placement surface, wherein a side of the charging placement surface facing the inner shell has a mounting groove, and the first magnetic suction portion is embedded in the mounting groove;
the inner shell has an installation surface corresponding to the charging placement surface, wherein the installation surface is provided with a charging portion;
the base forms the positioning slot.

6. The charging device according to claim 5, a counterweight portion is disposed on the base;
a counterweight tank is formed in the base, the counterweight portion is embedded in the counterweight tank, and the detachable cover of the counterweight tank is provided with a cover plate.

7. The charging device according to claim 5, the base forms a connecting groove on a side away from the inner shell, wherein an edge of the side away from the inner shell forms a connecting opening, and the connecting groove is connected to the connecting opening.

8. A security inspection device, comprises a metal detector and a charging device according to claim 1;
the metal detector, having a detection portion and a handle portion, wherein the detection portion is provided with a second magnetic suction portion and an metal sensing coil, the second magnetic suction portion is used to cooperate with the first magnetic suction portion of the charging device, and the metal sensing coil is used to detect metal.

9. The security inspection device according to claim 8, the body further forms an avoiding surface, the avoiding surface connects to the charging placement surface, and the avoiding surface is tilted relative to the charging placement surface, and the avoiding surface deviates from the metal detector, the avoiding surface is used to avoid the detection portion of the metal detector.

10. The security inspection device according to claim 8, the charging placement surface is tilted relative to a bottom surface of the body, wherein an angle between the charging placement surface and the bottom surface of the body is 40°-50°.

11. The security inspection device according to claim 8, the body forms an storage cavity, wherein the storage cavity forms a positioning slot for fixing a sensitivity calibration tester.

12. The security inspection device according to claim 11, the body comprises an outer shell, an inner shell and a base, wherein the inner shell is disposed on the base and forms the storage cavity with the base, and the outer shell is sleeved outside the inner shell;
the outer shell forms the charging placement surface, wherein a side of the charging placement surface facing the inner shell has a mounting groove, and the first magnetic suction portion is embedded in the mounting groove;
the inner shell has an installation surface corresponding to the charging placement surface, wherein the installation surface is provided with a charging portion;
the base forms the positioning slot.

13. The security inspection device according to claim 12, a counterweight portion is disposed on the base;
a counterweight tank is formed in the base, the counterweight portion is embedded in the counterweight tank, and the detachable cover of the counterweight tank is provided with a cover plate.

14. The security inspection device according to claim 12, the base forms a connecting groove on a side away from the inner shell, wherein an edge of the side away from the inner shell forms a connecting opening, and the connecting groove is connected to the connecting opening.

15. The security inspection device according to claim 8, the second magnetic suction portion is located at an end of the detection portion close to the handle portion, and the metal sensing coil is located at an end of the detection portion away from the handle portion.

16. The security inspection device according to claim 12, the security inspection device comprises at least two charging devices and at least one connecting member, wherein two ends of the connecting member are formed with avoiding slots, wherein the avoiding slots divide protruding ends on the connecting member, the protruding ends are embedded into the connecting grooves, and the edges of the base where the connecting openings are located are embedded into the avoiding slots.
